(19) United States
(12) Patent Application Publication
(10) Pub. No.: US 2014/0279584 A1
(43) Pub. Date: Sep. 18, 2014

(54) Evaluating Intellectual Property with a Mobile Device

(71) Applicant: IP Street, Spokane, WA (US)

(72) Inventors: Lewis C. Lee, Spokane, WA (US); Tammy M. Krieger, Bothell, WA (US)

(73) Assignee: IP Street, Spokane, WA (US)

(21) Appl. No.: 14/214,814

(22) Filed: Mar. 15, 2014

Related U.S. Application Data
(60) Provisional application No. 61/800,610, filed on Mar. 15, 2013.

(51) Int. Cl. G06Q 50/18; G06F 3/0481

(52) U.S. Cl. CPC G06Q 50/184; G06F 3/0481
USPC 705/310

(57) ABSTRACT

Techniques for aggregating patent and financial data, analyzing the data, and/or presenting the data in ways that are intuitive are described herein. In some instances, a user may employ a mobile device to provide input that identifies a company, patent document, classification, etc., and to receive a set of results screens that relate to the input. The set of results screens may include a variety of information related to patent documents.

### RELATED APPLICATIONS

This application claims the benefit of U.S. Provisional Application No. 61/800,610, filed Mar. 15, 2013, the entire contents of which are incorporated herein by reference. This application is related to U.S. patent application Ser. No. 13/447,260, filed Apr. 15, 2012. This application is further related to U.S. patent application Ser. No. 12/730,098, filed Mar. 23, 2010, which claimed benefit to U.S. Provisional Application No. 61/162,998, filed Mar. 24, 2009. This application is also related to PCT Application No. PCT/US2008/78861, filed Oct. 3, 2008 and U.S. patent application Ser. No. 12/245,680, filed Oct. 3, 2008, both of which claim priority to U.S. Provisional Application No. 60/977,629, filed Oct. 4, 2007, and to U.S. Provisional Application No. 60/978,088, filed Oct. 5, 2007. All of these applications are hereby incorporated by reference.

### COPYRIGHT NOTICE

A portion of the disclosure of this patent document contains material to which a claim for copyright is made. The copyright owner has no objection to the facsimile reproduction by anyone of the patent document or the patent disclosure, as it appears in the Patent and Trademark Office patent file or records, but reserves all other copyright rights whatsoever.

### BACKGROUND

Innovation is a key factor for many companies to succeed in a globally competitive world. Protection of innovation via intellectual property (IP) helps those companies convert innovation into business assets. Today, intangible assets represent a significant share of the market capitalizations of many of the most successful and innovative companies. Yet, to the business community and many professionals who are not IP legal experts, intellectual property generally, and patents specifically, remain somewhat of a mystery to fully understand, assess, and value.

### BRIEF DESCRIPTION OF THE DRAWINGS

The detailed description is set forth with reference to the accompanying figures. In the figures, the left-most digit(s) of a reference number identifies the figure in which the reference number first appears. The use of the same reference numbers in different figures indicates similar or identical items or features.

FIG. 1 illustrates an example architecture in which the techniques herein may be implemented.

FIG. 2 illustrates an example input screen that may be presented to a user to receive input for an analysis.

FIG. 3A illustrates an example ownership screen that contains information pertaining to ownership of a patent document.

FIG. 3B illustrates another example ownership screen that contains information pertaining to ownership of a patent document.

FIG. 4 illustrates an example reading screen that may enable a user to explore a patent document.

FIG. 5 illustrates an example a technology screen that contains information pertaining to relevant classifications associated with a patent document.

FIG. 6 illustrates an example a portfolio screen that contains information pertaining to a patent portfolio of an owner.

FIG. 7A illustrates an example landscape screen that contains a graphical chart showing a patent document relative to other patent documents of a relevant classification along with priority information.

FIG. 7B illustrates another example landscape screen that contains a graphical chart showing a patent document relative to other patent documents of a relevant classification along with priority information.

FIG. 8 illustrates an example a scope screen that contains information pertaining to a scope score of one or more claims in a patent document.

FIG. 9A illustrates an example screen to enable a user to access other types of information.

FIG. 9B illustrates an example portfolio breadth screen.

FIG. 9C illustrates an example competitive analysis screen for a company that compares portfolio quality distribution of owner, competitors, and class.

FIG. 9D illustrates an example acquisitions screen that presents patent documents transferred for a company.

FIG. 10 illustrates an example overview screen that includes general information about a patent document.

FIG. 11 illustrates an example scope analysis screen that shows information about patent documents that are most relevant to a target patent portfolio.

FIG. 12 illustrates a scrollable interface that enables a user to scroll through information items.

FIG. 13 illustrates an example growth screen that show an increase or decrease of patent documents owned by an owner.

FIG. 14 illustrates an example process to present results screens in response to receiving user input.

FIG. 15 illustrates an example process for presenting a graphical chart that plots patent documents according to classification and priority date.

FIG. 16 illustrates an example process to present various screens and other information related to patent documents.

### DETAILED DESCRIPTION

Described herein are architectures and techniques that aggregate patent and financial data, analyze that data, and present it in ways that are intuitive to non-IP professionals, such as inventors, product managers, executives, analysts, and financial professionals. In many instances, a user may employ a mobile device to provide input that identifies a company, patent document, classification, etc. and to receive a set of results screens that relate to the input. The set of results screens may include a variety of information related to patent documents.

As used herein a patent document may generally refer to content that is presented or to be presented to a governmental agency to obtain exclusive rights for an invention. For example, a patent document may include a patent application that is yet to be filed with a patent office, a patent application that has been filed with a patent office, a published application (e.g., publicly available document), an issued/granted patent, and so on.

The architecture and techniques may be implemented in many ways. The following disclosure provides several illustrative examples, but they are merely examples and are not intended to be limiting. The following implementations and contexts are but some of many.

### Example Architecture

FIG. 1 illustrates an example architecture 100 for aggregating, analyzing, and presenting intellectual property and business data. The architecture 100 includes an IP-based intelligence service 102 which aggregates patent, corporate, financial, and other IP data, analyzes that data, and serves that data over one or more networks 104 (hereinafter “the network 104”) to one or more devices 106 (hereinafter “the device 106”) that are employed by one or more users 108 (hereinafter “the user 108”). The network 104 may be a wireless or a wired network, or a combination thereof. The network 104 may be a collection of individual networks interconnected with each other and functioning as a single large network (e.g., the Internet or an intranet). Examples of such individual networks include, but are not limited to, telephone networks, cable networks, Local Area Networks (LANs), Wide Area Networks (WANs), and Metropolitan Area Networks (MANs). Further, the individual networks may be wireless or wired networks, or a combination thereof.

The device 106 may comprise any type of computing device including a server, a desktop PC (personal computer), a notebook or portable computer, a workstation, a mainframe computer, a handheld device, a netbook, an Internet appliance, a portable reading device, an electronic book reader device, a tablet or slate computer, a game console, a mobile device (e.g., a mobile phone, a personal digital assistant, a smart phone, etc.), a wearable computer (e.g., smart watch, smart glasses, etc.), or a combination thereof.

The devices 106 may include one or more network interfaces, one or more processors 110, memory 112, one or more input/output devices (e.g., mouse, keyboard, etc.), one or more cameras (e.g., rear-facing, front facing, etc.), one or more displays (e.g., touch screen, Liquid-crystal Display (LCD), Light-emitting Diode (LED) display, organic LED display, plasma display, electronic paper display, etc.), one or more sensors (e.g., accelerometer, magnetometer, etc.), and so on. The one or more processors 110 may include a central processing unit (CPU), a graphics processing unit (GPU), a microprocessor, a digital signal processor, and so on.

The memory 112 may include a client application 114 and/or a browser 116 to enable the user 108 to access the IP-based intelligence service 102. The client application 114 may include a mobile application, desktop application, other client-based applications, or any other application. The browser 116 many include a variety of browsers (e.g., Internet Explorer®, Firefox®, Safari®, Google Chrome®, etc.). The client application 114 and/or the browser 116 may operation in cooperation with the IP-based intelligence service 102 to perform a variety of operations described herein.

The user 108 may access the IP-based intelligence service 102 via the device 106 and conduct any type of analysis related to intellectual property. The user 108 may include an inventor, strategist, executive, business user, attorney, accountant, investment banker, venture capitalist, financial analyst, and so forth. Representative types of analysis may include, for example, searching, validity, infringement, freedom-to-operate, licensing, inventorship review, benchmarking, competitive portfolio analysis, portfolio metrics, and scoring/ranking. As one example, an inventor may access the IP-based intelligence service 102 to conduct patent searching with respect to the patentability of an idea and receive various results pertaining to that patentability search. Simultaneously, an executive may review a competitor's portfolio for benchmarking purposes, access the IP-based intelligence service 102 and see results pertaining to that review. In another example, a strategist may evaluate licensing opportunities, while another business user may ascertain the quality of a patent using one or more scoring tools provided by the IP-based intelligence service 102. These and numerous other uses of the IP-based intelligence service 102 are possible.

In one implementation, the user 108 may utilize a mobile device to input a limited amount of information. The information may include a patent identifier that identifies a patent document, a company identifier that identifies a company or patent owner, a classification identifier that identifies a classification, and so on. The information may be sent to the IP-based intelligence service 102 and a variety of results may be provided back to the user 108, such as ownership information for a patent document, information about a company's patent portfolio, landscape information about particular classifications in a landscape, patent scope information, and so on. In many instances, the results that are provided back to the user 108 may include a set of screens that are selected by the IP-based intelligence service 102. By doing so, the user 108 may obtain patent-based information in a simplified manner.

The IP-based intelligence service 102 may be implemented as one or more computing devices including servers, desktop computers, laptop computers, or the like. The IP-based intelligence service 102 may be configured in a server cluster, server farm, data center, mainframe, cloud computing environment, or a combination thereof. In one example, the IP-based intelligence service 102 may include any number of devices that operate as a distributed computing resource (e.g., cloud computing, hosted computing, etc.) that provides services, such as storage, computing, networking, and so on. To illustrate, the IP-based intelligence service 102 may be implemented as a cloud service that is accessible over the internet. Cloud services may not require end user knowledge of the physical location or configuration of the system that delivers the services. Common names associated with cloud services include “software as a service” or “SaaS”, “platform computer”, “on-dash demand computing”, and so on.

The one or more computing devices of the IP-based intelligence service 102 may include one or more processors 118 and memory 120. The one or more processors 118 may include a central processing unit (CPU), a graphics processing unit (GPU), a microprocessor, a digital signal processor, and so on. The memory 120 may include software and/or firmware functionality configured as one or more “modules.” The term “module” is intended to represent example divisions of the software and/or firmware for purposes of discussion, and is not intended to represent any type of requirement or required method, manner or necessary organization. Accordingly, while various “modules” are discussed, their functionality and/or similar functionality could be arranged differently (e.g., combined into a fewer number of modules, broken into a larger number of modules, etc.). Furthermore, while various operations are described as being performed by modules, any of these operations, and/or other techniques described herein, may be implemented as one or more hardware logic components, such as Field-Programmable Gate Arrays (FPGAs), Application-Specific Integrated Circuits (ASICs), System-on-a-chip systems (SOCs), Complex Programmable Logic Devices (CPLDs), etc. As illustrated in FIG. 1, the memory 120 includes a search engine 122 (e.g., module), an analysis module 124, and a presentation user interface (UI) module 126. The modules 122-126 may be executable by the one or more processors 120 to perform various operations, as described in further detail below.

The memory 120 may also include a patent database 128, a corporate database 130, a financial database 132, and a database for other information 134. The patent database 128 stores various patent documents, such as patent applications, granted patents, and file wrapper histories. The patent data from these various documents can be disaggregated and stored in various schemas to promote search efficiency and effectiveness. The corporate database 130 includes corporate data of various corporations and companies. The corporate data may include information such as number of employees, list of subsidiaries, functions or types of business, executive teams, corporate financial data (such as revenue, profits, etc.), and financial regulation filings. The financial database 132 may include information contained in financial markets, which may include, for example, stock price information, various metrics to measure a company's (e.g., P-E ratios, margin metrics, turnover ratios, etc.), and other data. The database for other information 134 may include data surrounding other forms of intellectual property besides parents, such as trademarks, trade secrets, know-how and copyrights. Further, the database for other information 134 may include other types of information, including information of non-patent literature or documents, such as journal articles, conference articles, manuals, brochures, and other publications, etc. In one implementation, the information may include part (such as Title, Abstract, etc.) of a non-patent document. In some implementations, the information may include the entire data of a non-patent document. While in the illustrated example the databases 128-134 are shown to be part of the IP-based intelligence service 102, in other examples one or more of the databases 128-134 may be separate from the IP-based intelligence service 102 and/or may be administered by another entity.

The memory 112 and/or 120 (as well as all other memory described herein) is representative of any number of forms of memory including both persistent and non-persistent memory. Memory is an example of computer-readable media. Computer-readable media includes volatile and non-volatile, removable and non-removable media implemented in any method or technology for storage of information such as computer readable instructions, data structures, program modules, or other data. Computer-readable media includes, but is not limited to, phase change memory (PRAM), static random-access memory (SRAM), dynamic random-access memory (DRAM), other types of random-access memory (RAM), read-only memory (ROM), electrically erasable programmable read-only memory (EEPROM), flash memory or other memory technology, compact disk read-only memory (CD-ROM), digital versatile disks (DVD) or other optical storage, magnetic cassettes, magnetic tape, magnetic disk storage or other magnetic storage devices, or any other non-transmission medium that can be used to store information for access by a computing device. In one implementation, memory may include computer-readable media in the form of volatile memory, such as Random Access Memory (RAM) and/or non-volatile memory, such as read only memory (ROM) or flash RAM. As defined herein, computer-readable media does not include transitory media such as modulated data signals and carrier waves. As such, computer-readable media includes non-transitory media.

The search engine 122 may be configured to discover various pieces of information in the databases 128-134. In one implementation, the search engine 122 may include a concept search engine, a keyword search engine, and a claim signature search engine. The concept search engine may identify relevant documents based on a concept included in or derived from a search query. For example, a user may provide a long textual description (such as a paragraph or page, or even a document, etc.) as an input query to the concept search engine. The concept search engine may then determine or identify a concept from the input query, and search across one or more datasets in the databases 128-134 for concepts that are the same as or similar to the identified concept according to one or more predetermined metrics. As one particular implementation, the concept search engine may be configured to employ a metric given by Latent Semantic Indexing (LSI) in which indexes of the data are pre-built to aid in the concept search.

The concept search engine enables various types of sophisticated searches, including patentability searches, validity searches, and freedom-to-operate searches. For example, to perform a patentability search, a user may input a description of a patentable idea, which may be a sentence, one or more paragraphs, or even a document. The concept search engine deduces a concept from that input and searches the concept across a collection of documents, which might include patents, applications, technology literature, research white papers, foreign documents, and so forth. In one implementation, the concept search engine may identify and return results which include information of the most relevant documents in a rank order of relevancy. The results may be presented graphically, or in a list form on a display of a computing device of a user. In the case of validity searching, a user can enter all or part of a claim of a patent to be evaluated. The concept search engine returns the most relevant documents, which can then be presented graphically, e.g., along a time line (or sorted by priority date), so that the user can quickly identify references that may be relevant and predate the priority date of the patent being evaluated. In the case of freedom-to-operate searching, the user can enter a description of a product or service being prepared for launch. The concept search engine may then evaluate this description of the product (or determine and evaluate a concept included in this description) against patent claims in granted US patents and published applications. Specifically, the concept search engine may maintain multiple latent semantically indexed collections, with the collections including entire patents and applications, or just portions thereof (e.g., just the claims, just the independent claims, just the abstract, etc.). In the freedom-to-operate case, the concept in the product/service description is searched relative to the claims and results are ordered according to relevancy with respect to the concept in the product/service description.

Additionally or alternatively, the search engine 122 may include the keyword search engine, in which a user may enter one or more keywords to search across the databases 128-134. Depending on implementation details, the keyword search engine may look for exact matches or approximate matches using fuzzy matching algorithms. The keyword search engine may employ Boolean operatives such as “AND”, “OR”, and “NOT”, and/or implement proximity algorithms (e.g., finding a specific word that is separated from another word within a predetermined number of words, etc.) and weighting (e.g., giving varying weights to one or more words in a search query). One example implementation of the keyword search engine employs SOLR technology of Apache Software Foundation.

Additionally or alternatively, the search engine 122 may include the claim signature search engine, which attempts to identify claims having similar signatures. One analysis tool provided by the IP-based intelligence service 102 is to derive a unique signature for a claim (e.g., an independent claim, a dependent claim, etc.) in a patent or patent application. In one implementation, a claim signature of a claim may be a function of each unique word and/or phrase found in the claim, relative to respective occurrence frequency of each unique word and/or phrase in a collection of patents and/or applications. For instance, the collection of patents and/or applications may be gathered from a common and/or same technology area as the patent or patent application for which a claim signature of the claim is to be determined. This allows the words and/or phrases to share a common ontology, vocabulary and/or taxonomy. In one implementation, the collection may be obtained based on classification codes, such as the U.S. Patent and Trademark Office (USPTO) classes and subclasses, or the International Patent Codes (IPC).

In some implementations, prior to determining a claim signature of a claim, the claim signature search engine may filter from the claim certain types of words and/or phrases that are useless in distinguishing the claim from other claims. By way of example and not limitation, the types of words and/or phrases to be filtered may include, for example, adjectives, adverbs, conjunctions, pronouns, articles, determiners, prepositions, etc. Additionally or alternatively, prior to determining a claim signature of a claim, the claim signature search engine may retain only certain types of words and/or phrases including, for example, verbs, nouns, etc., that may describe acts and/or subjects (or objects) involved or included in a product or service protected by the claim. Additionally or alternatively, in some implementations, the claim signature search engine may ignore words and/or phrases that indicate statutory classes (e.g., a process such as “method”, a machine such as a device, an article of manufacture such as computer readable media, a composition of matter such as a chemical compound, etc.) in determining a claim signature of a claim. Additionally or alternatively, when determining a claim signature of a claim, the claim signature search engine may ignore a preamble of the claim. Additionally or alternatively, when determining a claim signature of a claim, the claim signature search engine may ignore tenses of verbs in the claim.

Once a unique signature for a claim is found, the claim signature search engine may further identify other claims having a substantially similar signature for the claim. In one implementation, the claim signature search engine may find other claims using the same words/phrases or essentially similar words through the use of synonym or thesaurus libraries, stemming, truncating, or the like.

Additionally or alternatively, the search engine 122 may include other types of search engines in addition or alternative to the above three example search engines. For example, the search engine 122 may include an image search engine. An inventor may be interested in knowing whether a design or pattern may be eligible for obtaining a design patent application or trademark protection. The inventor may provide a pictorial or graphical image of that design or pattern with or without a textual description as an input query, and the image search engine may recognize and/or match the image using conventional image recognition and/or matching algorithms to determine a pattern and/or concept in the image. Based on the determined pattern and/or concept, the image search engine may identify one or more design patents and/or patent applications (or registered trademarks) that include this determined pattern and/or concept that is the same as or similar to the pictorial or graphical image. Additionally or alternatively, the image search engine may further search the Internet to determine if anyone and/or any company has published a similar design or pattern on the Internet. The image search engine may return search results including the most relevant results (e.g., design patents, patent applications, trademarks, Internet-published images, etc.) to the inventor in an order of relevancy.

In one implementation, the search engine 122 may perform multiple types of searches concurrently (e.g., simultaneously, overlapping, etc.) or sequentially, with each type of search returning a results set. For example, the concept search engine, the keyword search engine, and/or the claim signature search engine may be run relative to one or more inputs pertaining to a common search strategy. For instance, a user might be interested in finding patents relevant to a particular patent or patent application. The user may provide the particular patent or patent application (e.g., an electronic copy of the particular patent or patent application, an identified number such as application number or publication number of the particular patent or patent application, etc.) to the search engine 122. An excerpt from the particular patent or application may be provided to the concept search engine. Additionally or alternatively, one or more keywords from the particular patent or application may be provided to the keyword search engine. Additionally or alternatively, one or more claim signatures pertaining to one or more claims in the patent or application may also be input to the claim signature search engine. In one implementation, each search engine performs respective searches and generates result sets. The results sets are then compared with each other to determine whether one or more documents are found in two or more of the result sets. When a document is identified by multiple searches, a higher confidence may be applied to that document that it is relevant to the patent or application of interest. The combined results sets may be graphically presented akin to a Venn diagram, for example, where sets of circles or other shaped enclosures each encircling respective results sets, with the result sets overlapping at documents common to any combination of two or more result sets.

In some implementations, the search engines may cooperatively perform a search in a way that part or all of the search results from a search engine may be provided to one or more other search engines as an input and/or as a pool from which search results are retrieved. By way of example and not limitation, a user may provide a claim of a patent or patent application for an invalidity search. Upon submitting a textual description of the claim to be invalidated to the search engine 122, the IP-based intelligence service 102 may direct the claim signature search engine to find one or more patents and/or patent applications that includes claims having claim signatures being similar to or the same as a claim signature of the claim to be invalidated. Upon finding one or more patents and/or patent applications that includes claims having claim signatures being similar to or the same as a claim signature of the claim to be invalidated, the keyword engine, for example, may extract one or more keywords from the top N (where N is a positive integer and selectable by the user or predefined by the IP-based intelligence service 102) patents and/or patent applications that include claims having claim signatures that are most similar to the claim signature of the claim to be invalidated. The keyword engine may then use these extracted keywords to find one or more patents and/or patent applications that are relevant to these extracted keywords. Additionally or alternatively, the concept search engine may extract excerpts (e.g., text corresponding to abstract, background, summary, overview, a portion of detailed description, etc.) from the top M (where M is a positive integer and selectable by the user or predefined by the IP-based intelligence service 102) patents and/or patent applications that include claims having claim signatures that are most similar to the claim signature of the claim to be invalidated. The concept search engine may then determine concepts from the excerpts and perform an invalidity search using the determined concepts. In some implementations, search results obtained from one or more search engines may be compared, and are ranked in a way that a higher ranking is given to a patent or patent application having been found by more than one search engine.

In one implementation, one or more of the search engine of the search engine 122 (the concept search engine, the keyword search engine, and/or the claim signature search engine) may support a regular search for a user. For example, the search engine 122 may receive, from the user, any information associated with a patent document such as a filing date, an application number, a publication number, a classification, etc., and retrieve or return a list of patent documents or patent information that corresponds to the received information from the user. For example, the user may input a classification (e.g., a patent classification adopted by the United State Patent and Trademark Office (USPTO)). In response to receiving the inputted classification, the search engine 122 may retrieve or return a list of patent documents classified under the inputted classification. As discussed in more detail below, the search engine 122 may present the list of patent documents graphically, for example, as cumulative line graph(s), trend(s) and/or rate(s) of change of number of granted patents and/or number of filed patent applications over a predetermined period of time.

Additionally or alternatively, the search engine 122 may receive a query related to a patentability search. For example, the search engine 122 may receive a textual description of a patent claim or a textual description that substantially describes the patent claim from a user. In one implementation, the search engine 122 may receive the textual description by receiving a document including the textual description of the patent claim or the textual description that substantially describes the patent claim. In some implementations, the search engine 122 may receive identification information of a patent document that includes the textual description of the patent claim. The identification information of the patent document may include an application number, a publication number, a patent number, and/or a combination of information associated with the patent document that may uniquely identify the patent document (such as a combination of a name of an inventor and a filing date, etc.). The search engine 122 may access the patent document and extract the textual description of the patent claim from the patent document. Alternatively, the search engine 122 may access a prosecution history or file wrapper associated with the patent document and extract the textual description of the patent claim from the prosecution history or file wrapper associated with the patent document. In one implementation, the search engine 122 may determine a document in the prosecution history or file wrapper that includes a latest version of the patent claim and extract the textual description of the patent claim from the determined document.

In response to receiving the textual description of the patent claim or the textual description that substantially describes the patent claim, the search engine 122 may obtain or retrieve a ranked list of results for the patent claim across a library of documents or from a database, for example. The database may include, but is not limited to, a patent database provided and/or supported by a patent office of a particular country (e.g., a USPTO (United States Patent and Trademark Office) database, a PAIR (Patent Application Information Retrieval) database, EPO (European Patent Office) database, WIPO (World Intellectual Property Organization) database, SIPO (State Intellectual Property Office of the P.R.C.) database, etc.), and any other databases that are provided by public and/or private institutions over the world. In one implementation, the ranked list may include patent documents ranked in a predetermined order (e.g., a decreasing order or an increasing order) of likelihood of rendering the patent claim unpatentable. Additionally or alternatively, the ranked list may include links of patent documents ranked in a predetermined order. In some implementations, the search engine 122 may further receive a date from a user. In an event that a date is received from a user, the search engine 122 may retrieve or return a ranked list of results including patent documents that have a filing date or a priority date prior to the date received from the user in a predetermined order as described above. Additionally or alternatively, the search engine 122 may perform a latent semantic-based concept search across a library of documents using the textual description of the patent claim as an input. Additionally, the search engine 122 may present the ranked list of results graphically. By way of example and not limitation, the search engine 122 may present the ranked list as a scatter plot having a first axis of time to represent dates of the retrieved patent documents and a second axis of relevancy to represent the likelihood of rendering the patent claim unpatentable.

In some implementations, the search engine 122 may receive a query related to an invalidity search. The search engine 122 may receive the query in a form of identification information of a patent document including a patent claim to be invalidated, a document including a patent claim to be invalidated and/or a textual description of a patent claim. In an event that the search engine 122 receives identification information of a patent document, the search engine 122 may access the patent document and extract the patent claim to be invalidated from the patent document. In either case, the search engine 122 may formulate the query based on the patent claim, for example, using the claim language of the patent claim. The search engine 122 may perform a search using any of the above described search engines, such as the concept search engine, the keyword engine, and/or the claim signature search engine. The search engine 122 may search a library of documents or a database (e.g., USPTO database, etc.) using the formulated query.

In one implementation, the search engine 122 may obtain a ranked list of results based on the query. For example, the search engine 122 may obtain or retrieve one or more references that include one or more claim features or claim limitations of the patent claim. The one or more references may include, but are not limited to, one or more issued patents, published patent applications and/or non-patent literature such as journal articles, news, etc. Additionally, the search engine 122 may rank the one or more references based on respective one or more claim features or claim limitations included or found in the one or more references. By way of example and not limitation, the search engine 122 may rank the one or more references based on number of claim features or claim limitations of the patent claim that are included or found in the corresponding one or more references. In one implementation, a feature or claim limitation of a patent claim may include, but is not limited to, a group of words between any two delimiters, a group of words between two semicolons, a group of words between a semicolon and a full stop, etc. Additionally, the search engine 122 may further propose one or more combinations of the one or more references that may combine to invalidate the patent claim (e.g., to render the patent claim obvious). For example, the search engine 122 may propose a combination of two or more references that, in combination, include all claim features or claim limitations of the patent claim. In response to obtaining or retrieving the ranked list of results, the search engine 122 may return the ranked list to a computing device of a user for display. In some implementations, the results of the ranked list may include patent documents having associated dates. The search engine 122 may present the ranked list as, for example, a scatter plot having a first axis of time to represent the dates of the patent documents and a second axis of relevancy within the invalidity search.

In another implementation, the search engine 122 may receive a search query related to a freedom-to-operate search from a user. The user may use any of the above search methodologies to prepare and submit the search query to the search engine 122. Additionally or alternatively, the search engine 122 may receive a date in the search query. Additionally or alternatively, the search query may include, but is not limited to, a country name or code, a classification of a taxonomy, a name of an assignee, a number of an inventor, a keyword, a textual description of a concept and/or any patent-related information of a patent document. In response to receiving the search query, the search engine 122 may retrieve or return a plurality of expired patents based on the received search query. Additionally or alternatively, the search engine 122 may retrieve or return one or more patent applications that are published and abandoned based on the received search query. In an event that a date is received in the search query, the search engine 122 may retrieve or return expired patents that have an expiration date prior to and/or on the received date. By finding patents that have been or will be expired after a particular date, for example, the search engine 122 allows a user to determine whether and when he/she may make, sell and/or import products and/or services protected by these patents. In some implementations, the search engine 122 may receive an input query including a textual description of a product or service that is proposed or planned to be made, sold and/or imported. Additionally, the input query may include a country name or code for a country in which the product or service is proposed or planned to be made, sold and/or imported. Upon receiving the input query, one or more of the search engines (e.g., the claim signature search engine) may look for one or more patents and/or patent applications that include claims may read on the proposed product or service, and return search results of these patents and/or patent applications in an order of relevancy (such as the probability that the proposed product or service will infringed a patent or patent application, or the probability that a claim of the patent or patent application will read on the proposed product or service, for example).

In some implementations, the search engine 122 may allow a user to submit a query for an infringement search (i.e., search for potential infringing products or services). By way of example and not limitation, the search engine 122 may receive a textual description of a patent claim of a patent or patent application from the user. The search engine 122 may receive the query in a form of identification information of a patent document including a patent claim for infringement search, a document including a patent claim for infringement search and/or a textual description of a patent claim for infringement search. In an event that the search engine 122 receives identification information of a patent document, the search engine 122 may access the patent document and extract the patent claim for infringement search from the patent document. In either case, the search engine 122 may formulate the query based on the patent claim, for example, using the claim language of the patent claim. In some implementations, the query may further include a technological or industrial field that a potentially infringing product or service is being looked for. Additionally or alternatively, the search engines may determine a technological classification for the patent claim based on a classification described in the patent or patent application of the claim, and limit the infringement search to the determined technological classification. The search engine 122 may perform a search using any of the above described search engine 122. The search engine 122 may search a library of documents, the databases 128-134, or a publicly available database (e.g., USPTO database, etc.) using the formulated query.

In one implementation, the search engine 122 may search for any patent or patent application that includes a claim that is relevant or similar to, and has a later effective filing date than, the received patent claim for which the infringement search is being conducted. Such an approach takes into account that companies with patents having similar claims but with later priority dates are likely to be producing products covered by the claims and are, therefore, likely candidates for infringement. By way of example and not limitation, a relevancy or similarity between two claims may be determined based on number of claim features or claim limitations that are common in the two claims. Additionally or alternatively, the search engine 122 may examine prosecution histories of granted patents and/or filed patent applications with later effective filing dates and determine which granted patents and/or filed patent applications include a prosecution history in which a patent or a patent application for which the infringement search is being conducted has been cited to reject claims of the granted patents and/or filed patent applications.

In some implementations, the search engine 122 may return a ranked list of results to the device 108 for presentation to the user 108. The search engine 122 may rank the results based on relevancy or similarity to the patent claim for infringement search. Additionally or alternatively, the search engine 122 may rank the results based on types of rejections (§102 rejections, §103 rejections, etc.) used for rejecting claims of patents or patents applications found in the results. The ranked list of results may include owners of patent documents (i.e., granted patents and/or filed patent applications) and information (such as products that are launched within a predetermined period of time before and/or after filing dates or publication dates of the patent documents, etc.) associated with the owners of the patent documents. Additionally or alternatively, the search engine 122 may present the ranked list of results graphically, for example, as a scatter plot having a first axis of time to represent dates (such as filing dates or priority dates) of the patent documents and a second axis of relevancy or similarity within the infringement search. In some implementations, the search engine 122 may further allow a user to input a date. In response to receiving the date from the user, the search engine 122 may retrieve patent documents having a filing date or a priority date after the received date, and return a ranked list of results to a device for presentation to a user.

Additionally or alternatively, in some implementations, the search engine 122 may search the Internet, online retailers, online shopping services, etc., for any product or service that may infringe the claim. Additionally or alternatively, a user may indicate a specific industrial or technological field that he/she is interested in finding any potential infringement product or service. Additionally or alternatively, the search engine 122 may determine an industrial or technological field to look for any potential infringing products or services based on the technological classification given to or determined by the search engine 122. Additionally or alternatively, the search engine 122 may determine or expand a scope of industrial or technological fields to look for any potential infringing products or services by determining an industrial or technological sector to which a patent owner of the patent or patent application associated with the claim belongs. The search engine 122 may determine the industrial or technological sector to which that patent owner belongs to based on, for example, company information stored in the corporate database 130, the financial database 132, national or international database storing company directories such as New York Stock Exchange, NYSE Amex Equities, etc. Additionally or alternatively, the search engines may search websites of individual companies that are found to be within the same industrial or technological sector, field or classification as the claim, the patent or patent application that includes the claim, and/or the patent owner of the patent or patent application that includes the claim.

In some implementations, the memory 120 may further include the analysis module 124 that is executable by the one or more processors 118. The analysis module 124 may be configured to analyze the results returned by one or more of the search engine 122 or to analyze patents/applications that are identified by a user. The analysis module 124 may provide various analysis tools to return results in text, or as graphs, depending upon the intended knowledge to be conveyed. The analysis module 124 may perform many types of analyses. One type of analysis provided by the analysis module 124 may include a relevance analysis, in which results from the search engine 122 are returned and organized according to their relevance to the input query. A determination of how relevant documents are to a query may depend on a type of search being performed (concept search, keyword, both, etc.), a determination to be made based on the search (patentability, validity, freedom-to-operate, infringement, etc.), a taxonomy being employed (public, private, etc.), and the like. For example, the concept search engine and the keyword search engine may provide relevance values for the returned documents, and outputs may be provided in many forms, including in list form and/or on graphical presentations.

Additionally or alternatively, the analysis module 124 may include a trend analysis. The trend analysis may be used to determine how patents (and/or patent applications) and other data evolve over time. Associations among the data from the various databases 128-134 may be applied in this temporal based trend analysis for identification of associations and patterns. For instance, the trend analysis may discover macro filing trends of one or more intellectual property (or patent) owners or inventors, accumulation trends of patents or patent applications of the one or more intellectual property (or patent) owners or inventors in various categories or taxonomy levels, micro filing trends of the one or more intellectual property (or patent) owners or inventors among associated technologies, portfolio drift, and so forth.

In one implementation, the analysis module 124 may further include a distribution analysis. The distribution analysis may be used to determine patterns in the aggregated data. For instance, patent data results may be pivoted among any number of factors to discover distribution information. Following a search, a user may wish to know the top owners in the results sets, or the top inventors. Any number of pivots may be available, including owners, inventors, law firms, examiners, class, sub class, and so forth.

In some implementations, the analysis module 124 may include a portfolio analysis tool that may be used to support more sophisticated landscape studies of intellectual property landscapes and provide a unique breakdown of the various data. In one implementation, the portfolio analysis tool employs a taxonomical approach to landscapes, defining various levels and sublevels of technologies and then mapping patent documents (e.g., grants, applications, pre-filed invention disclosure documents, etc.) against the taxonomy. The portfolio analysis tool supports various public taxonomies, such as the USPTO classification system of classes and subclasses, as well as private or customized taxonomies.

Furthermore, a growth rate analysis tool may further be included in the analysis module 124, and may be employed to evaluate not only how patent assets are accumulated over time, but also various growth rates such as filing rates and acceleration rates. The growth rate analysis tool may be able to compute a filing rate based on the number of filings period over period (e.g., year over year, quarter over quarter, etc.) or by computing a first derivative of the accumulation curve. In one implementation, the growth rate analysis tool may further be able to compute an acceleration rate based on an increase or decrease in filings for a period over period, or by computing a second derivative of the accumulation curve. The growth rate analysis may be applied to essentially any result sets.

The analysis module 124 may further include a patent assessment component, which analyzes patents and/or patent applications based on quality metrics. In one implementation, the patent assessment component evaluates patent quality based upon the strength or breadth of the claims in the patent and/or patent application. In one implementation, the patent assessment component may include a claim scope engine and a claim signature engine. In one implementation, the claim scope engine is configured to evaluate a patent and/or patent application based on the claim language and terms used in the claim. In some implementation, the claim scope engine may evaluate a patent and/or patent application based on the claim language and terms used in the claim relative to all the other claims against which the claim is to be compared. In one particular implementation, a claim from a particular patent or application is compared to all the claims in all the patents and/or patent applications in a particular class or subclass of a classification or taxonomy system (such as USPTO classification, for example). Alternatively, the collection of patents and/or applications could be a result of a search, such as the claim signature search, the keyword search and/or the concept search. The claim scope engine computes a scope of a particular patent claim as a function of a count of words and/or phrases used in the particular claim and a frequency count of the words and/or phrases from the particular patent claim as found in the plurality of patent claims. More particularly, the claim scope engine first identifies each and every word and/or phrase used in claims in all patents and/or applications against which the claim is to be compared. The claim scope engine may employ various language processing techniques to identify individual words, such as use of synonym libraries, removal of stop words, use of stemming, and so forth. In some implementations, the claim scope engine may filter from the claim certain types of words and/or phrases that are useless in distinguishing the scope of the claim. By way of example and not limitation, the types of words and/or phrases to be filtered may include, for example, adjectives, adverbs, conjunctions, pronouns, articles, determiners, prepositions, etc. Additionally or alternatively, the claim scope engine may retain only certain types of words and/or phrases including, for example, verbs, nouns, etc., that may describe acts and/or subjects (or objects) involved or included in a product or service protected by the claim. Additionally or alternatively, in some implementations, the claim scope engine may ignore words and/or phrases that indicate statutory classes (e.g., a process such as “method”, a machine such as a device, an article of manufacture such as computer readable media, a composition of matter such as a chemical compound, etc.) in determining the scope of the claim. Additionally or alternatively, when determining the scope of the claim, the claim scope engine may ignore a preamble of the claim. Additionally or alternatively, when determining the scope of the claim, the claim scope engine may ignore tenses of verbs in the claim. Once each unique word is identified, that word is counted in each claim in the collection of patents/applications to discover its frequency of occurrence.

Each claim can then be assigned a first dimensional value (e.g., a y-value) based on the number or count of unique words in the claim and a second dimensional value (e.g., an x-value) based on the commonness of the words used in the claims as governed by the frequency counts throughout the entire collection. That is, words are said to be more common if they have relatively higher frequency values within the collection and less common if they have relatively lower frequency values within the collection. In one implementation, the y-value is a function of the count of unique words in a claim, such as the inverse of the unique word count (i.e., 1/UWcount), so that a larger y-value is assigned to claims with fewer unique words and a smaller y-value is assigned to claims with more unique words. In this manner, this first value or coordinate represents an underlying assumption or premise that claims with fewer unique words tend to be broader than claims with more unique words. Said more simply, shorter claims tend to be broader than longer claims. This is not always the case, particularly when considering claims in life sciences or chemical arts, but is considered to be a correct generalization.

The x-value may be a function of the collection-based frequency counts associated with each of the words in the claim. One particular implementation employs an algorithm of one divided by the sum of the inverse of each word's associated frequency count (i.e., 1/sum (1/Freq wd1+1/Freq wd2+ . . . +1/Freq wd n), where “Freq wd1” is the count of a number of occurrences of unique word 1 in the claims from the collection of patents/applications). Less common terms result in larger denominator values (i.e., 1/low_freq_value>1/high_freq_value), thus making the overall result smaller. A larger x-value is thus assigned to claims that use relatively more common words for the collection of patents/applications being evaluated and a smaller x-value is assigned to claims that use relatively less common words. In this manner, this second value or coordinate represents an underlying assumption or premise that claims with more common words tend to be broader than claims with less common words. Once again, this may not always be the case, but is considered to be a correct generalization.

With the x-value and y-value, each claim can then be plotted in a two-dimensional graph which visually reveals how a particular claim compares in terms of word count and commonness to all of the other claims in the collection of patents being reviewed. Thus, for a given patent having M claims, the plot may show M designators or marks in a two-dimensional area. The location of the designators or marks indicates whether the claims are relatively broader or narrower within the collection. Claims with x- and y-values closer to the origin (i.e., claim has many words and the words contain uncommon words) are said to be narrower than claims farther from the origin (i.e., claims with fewer words and the words are more common).

By using two vectors, the claim scope engine also moderates each of the underlying assumptions or premises. For example, if a claim is relatively shorter, but uses very uncommon terms, a patent practitioner might still consider the claim to be narrow due to the restrictive language in the claim. Accordingly, the first vector or word count (i.e., y-value) may receive a relatively higher value, but the second vector or commonness value (i.e., x-value) would receive a relatively lower value. This would move the point back closer to the origin than had the claim been short and used very common words for that technology sector or collection.

With the x- and y-values, the claim scope engine may also compute a distance value from the origin. In this manner, each claim in a patent or patent application may have a unique distance value based on these two values or coordinates. The distance value may then be used to rank or otherwise order any results from the search engine 122 and analysis tools or analysis module 124. Further, the distance value may be used to alter visual appearances in various graphical outputs, to convey to the user which assets in a given view may be broader than others. For instance, in a portfolio view or concept scatter plot, the distance value may be employed to alter sizes, the color intensities or color frequencies of designators or marks in results shown in the portfolio view or concept scatter plot to visually convey relative quality or breadth of corresponding claims in patents and/or patent applications.

The claim signature engine is configured to evaluate a patent and/or patent application by identifying a unique signature of one or more claims (e.g., one or more independent claims, dependent claims, etc.) contained in the patent or application. More particularly, the claim signature engine computes a signature of a particular claim as a function of the words and/or phrases used in the particular claim and a frequency count of the words and/or phrases in a large collection of claims from multiple patents and/or patent applications. The unique signature for a claim can also be presented in a graphical user interface that identifies the words in a claim and how common those words are to a collection of claims in a similar technology space.

The analysis module 124 may further include other types of scoring algorithms that are used to assess patents or patent applications. Whereas the claim scope engine and the claim signature engine represent scoring engines that assess the actual claim language, other scoring engines may attempt to assess quality, value, innovativeness, or other characteristics of a patent or patent application based on other factors. Examples of other types of scoring algorithms might include forward citation algorithms, backward citation algorithms, a combination of forward and backward citation algorithms, maintenance fee payment algorithms, and file wrapper history algorithms. Each of these scoring algorithms attempts to assess a quality of a patent and/or patent application based on these various factors or characteristics of the patent or patent application.

For example, a forward citation algorithm may assess quality of a patent or patent application of interest by determining a number of times the patent or application is cited or referenced by other patents and/or patent applications, and assign a higher score to the patent or application if the number of times that patent or application is cited or referenced by other patents and/or patent applications is larger.

A backward citation algorithm may assess quality of a patent or application by determining number (and/or recentness) of references that the patent or application cited or referenced during its prosecution. The backward citation algorithm may give a higher or same weight to non-patent literature than patents (and/or patent applications) and/or assign a higher score to the patent or patent application if the number (and/or recentness) of references that the patent or patent application cited during its prosecution is lower.

A maintenance fee algorithm may assess quality of a patent or application by determining whether one or more maintenance or annuity fees have been paid in time or failed to be paid for the patent or application, and assign a higher score to the patent or application the longer it is maintained. The rational for this algorithm is that companies will not maintain patents or applications that are of low quality, low value, and/or are out dated, as long as they maintain patents or applications that are of high quality, high value, and/or are of continued commercial significance.

A file wrapper history algorithm may assess quality of a patent or application by determining its prosecution history before a patent office, giving a higher score to the patent or application if the prosecution history is shorter in time, involved fewer claim amendments and/or office actions, involved less extensive claim amendments, etc. In some implementations, the analysis module 124 may further normalize the scores returned by the above scoring algorithms for the patent or application based on respective predetermined thresholds or respective average numbers for patents or applications in the same technological field or classification (e.g., USPTO classification), before the same patent examiner, or the like.

By implementing multiple and various engines, the analysis module 124 is capable of evaluating patents and/or patent applications through a combination of multiple scoring algorithms. For instance, a user may assess a single patent using one or more of the claim scope engine, the claim signature engine, and one or more of the other scoring engines, such as forward and backward citation algorithms, maintenance fee algorithms, and so forth. In one implementation, the multiple scoring algorithms for evaluating a patent or patent application may be presented via a user interface that enables the user to select one or more combinations of scoring algorithms with which to rank or sort a collection of patents or applications. For example, the analysis module 124 may select a number of scoring algorithms from the scoring engines (e.g., the claim scope engine and the claim signature engine) and/or other scoring algorithms, and use these selected scoring algorithms to assess the quality of a patent or application. In one implementation, the analysis module 124 may generate a composite score (e.g., a combination of weighted scores returned from these selected scoring algorithms). In some implementations, the analysis module 124 may individually return these scores from the scoring algorithms to enable representing various quality metrics (such as claim scope, etc.) for the patent or application.

The analysis module 124 may further implement a file wrapper tool that determines a change in claim scope that resulted from prosecution of a patent application to issuance. In one implementation, the file wrapper tool examines independent claims in a published application and identifies the broadest claim. The file wrapper tool may retrieve distance values calculated by the claim scope engine for each claim in the patent application, and select the claim with the largest distance value, which is representative of the broadest claim. The file wrapper tool next examines independent claims in the corresponding issued patent and identifies its broadest claim. Once again, the file wrapper tool may retrieve distance values calculated by the claim scope engine for each claim in the granted patent, and select the claim with the largest distance value.

The file wrapper tool then computes a change value representing a change in scope from the broadest claim in a patent application relative to the broadest claim in the granted patent. In one implementation, the file wrapper tool computes a percentage change from a first distance for an application claim to a second distance of a granted claim. This percentage serves as a proxy for the change in scope of the patent as a result of amendments made during prosecution. This change-in-scope approximation is very useful to a practitioner as it provides insights as to how much activity occurred during prosecution without having to review the file wrapper history. Additionally or alternatively, the file wrapper tool may compute a change value representing a change in scope for a particular claim (e.g., an independent claim) in a patent application from a particular stage (e.g., at the time of filing the patent application, at the time of filing a response to an Office Action, etc.) to the time when the particular claim (possibly with claim amendments) is allowed. The file wrapper tool may identify or follow that particular claim throughout the prosecution of the patent application based on its claim number, similarity or correlation between claims in responses for two consecutive Office Action, etc. The file wrapper tool may compute a change value for each change in scope for that particular claim between two Office Actions or between responses filed for two Office Actions, etc. The file wrapper tools may graphically or textually (e.g., in tabular or list form, etc.) present each change value to a user. This allows the user to quickly and easily identify a particular stage or point in time that an activity that may substantially affect the scope of the claim. Moreover, this may also allow the user to focus on activities occurred at that particular stage or point in time to determine whether claims of one or more patents and/or patent applications cited for rejecting the claim at that particular stage or point in time are related to a product or service covered by the claim at issue and whether a subset of the one or more patents and/or patent applications are worth to be acquired or a license thereof is worth to be obtained.

Furthermore, results from two or more analysis tools included in the analysis module 124 may be combined to provide even greater insights for the user. For instance, a user may use the portfolio tool to illustrate patent assets of a particular owner or inventor. In these views, the graphical elements used to represent the assets may be modified (e.g., size, color, intensity, etc.) based on the claim scope score. That is, assets deemed relatively broader (i.e., higher distance value) will be enlarged or changed in color or otherwise modified relative to other assets. As another example, results from search engines may be sorted or graphically represented according to claim scope.

One or more scenario wizards may also be stored in memory 120 and executed by the one or more processors 118. Several example scenario wizards are shown for discussion purposes. Each scenario wizard guides a user through a set of questions or requests that form inputs to the various analysis tools. In this manner, the user need not be an IP specialist or even familiar with IP. Instead, the wizards extract appropriate information, initiate proper tools, and present results that are intuitive and actionable to the user.

One scenario wizard is a claim language evolution wizard in which a user is guided through a set of analytical tools to view how particular claim language in a patent document has evolved over time. A certain phrase or keyword may be input and tracked through various patent documents over a period of time to help the user ascertain how that claim language has evolved in a taxonomy. As an example, the user may be asked to input a word or phrase, and all claims containing that word or phrase are presented along a time line.

Another scenario wizard that may be employed is a taxonomy-based landscape wizard in which patent landscapes are plotted according to a technology-relevant taxonomy that classifies patent documents according to particular classifications. The taxonomy-based landscape wizard asks the user for entry of some information that helps identify a set of patent assets, such as a company name, inventor, technology area, search query, and so forth. The taxonomy-based landscape wizard may further ask for time constraints or date ranges and whether the user would like to apply a patent assessment score, such as claim scope to the results. The landscape-based wizard may also inquire as to whether the user would like to consider comparing the results to another company, inventor, and so forth.

The taxonomy-based landscape wizard takes the simple input, such as an owner name, and maps relevant patent documents to the technology taxonomy. The patent documents can further be arranged according to priority date so that a user can see how the assets align relative to both the classification as well as the timeframe within which the asset was procured. Additionally, graphical elements representing assets may be scaled, colored, or otherwise visually varied to represent assessment scores applied to the patent assets. The taxonomy-based landscape wizard allows a user to view landscapes at high level and iteratively drill into lower and lower levels to see how those assets are grouped. From such taxonomy-based landscapes, users can identify risk areas and opportunities as well as white space in which very little patent activity has taken place to date.

A freedom to operate wizard facilitates another scenario that may be offered by the IP-based intelligence service 102. The wizard prompts the user to enter a description of a technology that is about to be released, and an identification of which geographical markets it is to be released. This description is entered as a query in the concept search engine, and the limiting parameter of “claims only” is automatically selected and the corresponding patent territories are selected. In this manner, the description is searched against all claims in the patent database pertaining to the selected patent territories. The returned results provide a listing of relevant patent claims that may then be evaluated against the description of the product to inform the user of any potential risk of infringement were the user to launch a product of that description.

A validity analysis wizard is yet another scenario that may be offered which allows a user to evaluate the validity of a patent claim. The user is prompted to enter a patent or application number and if known, to identify one or more claims in the patent to be evaluated for validity. In response, the validity analysis wizard accesses the patent records for the entered patent number, extracts the identified claim and any priority data, and enters the claim as a query to the concept search engine. The claim is then searched against all of the patent documents in the patent database (regardless of territory or country) and/or the database for non-IP data including printed publications such as non-patent literature, journals, brochures, etc. Documents that pre-date the priority data associated with the patent claim may then be analyzed to determine whether or not the claim, as issued or published, is likely valid or not.

Another scenario that may be offered by the IP-based intelligence service 102 is a find a licensee/licensor scenario. In this particular scenario, a user may be prompted to enter a description of relevant technology, or identify a patent number. This input is then fed into the concept and/or keyword search engines, and the results are analyzed to identify current companies that have the most relevant assets. After the user has identified a collection of potential companies with similar interests, additional analysis can be used with the growth rate analysis modules to identify which of this collection of companies may be actively patenting in this particular area as evidenced by acceleration trends in that particular technology area. This list may then be ranked and organized and presented back to the user to help the user identify a potential licensee or licensor.

The presentation user interface (UI) 126 is also shown stored in the memory 120 for execution on the one or more processors 118. The presentation UI 126 lays out the various results from the search, as analyzed by their various analysis modules, for presentation back to the users. The presentation UI 126 may rely on any number of visual graphics. The specific visual graphics employed in any given analysis or scenario wizard are configured to convey intuitively the results of the search and analysis.

In one implementation, the memory 120 may further include a taxonomy module. The taxonomy module enables a user to select a taxonomy from a plurality of taxonomies that are stored in a taxonomy database. In one implementation, the plurality of taxonomies may include, for example, publicly available taxonomies and private taxonomies. Publicly available taxonomies may include, but are not limited to, taxonomies provided and/or supported by government agencies such as patent offices of various countries (such as USPTO, SIPO, etc.) and/or organization (such as PCT, EPO, etc.), taxonomies defined by standards setting organizations, etc. Private taxonomies may include, for example, a taxonomy defined by a private company. Additionally or alternatively, in some implementations, the plurality of taxonomies may include one or more customized taxonomies including, for example, a taxonomy customized for a particular technology, a taxonomy customized for a particular company, a taxonomy customized for a particular industry, etc.

In one implementation, the taxonomy module may provide the plurality of taxonomies to a user for selecting a taxonomy therefrom. By way of example and not limitation, the user may perform a patent search using the IP-based intelligence service 102. The user may select a particular taxonomy from one or more taxonomies available to him/her, and provide a search query to one or more of the search engine 122 (e.g., the concept search engine, the keyword search engine, and/or the claim signature search engine). The search engines 122 may then perform a search for patents and/or applications based on the search query and the selected taxonomy. In some implementations, the search engine 122 may return search results to the user in a graphical form, a tabular form and/or a list form. In one implementation, the search results may be arranged based on relevancy of the returned patents and/or applications to the search query. Additionally or alternatively, the search results may be arranged based on classifications or categories of the selected taxonomy to which respective patents and/or applications belong. In one implementation, the search results may include number of hits (i.e., number(s) of patents and/or applications) for each classification or sub-classification. The user may select a particular classification which may be expanded to show information of the patents and/or applications under that particular classification.

In some implementations, a user may want to find one or more patents and/or applications within a particular classification or category such as electronic commerce. The user may select a particular taxonomy from one or more taxonomies available to him/her. The user may further input one or more particular classifications or categories (e.g., “electronic commerce”, etc.) under the selected taxonomy he/she wants to find related patents and/or applications. Alternatively, the user may input one or more specific classification codes (e.g., a specific classification code for “electronic commerce” in this example) to the IP-based intelligence service 102. The IP-based intelligence service 102 or the search engine 122 may perform a search for the user based on a search query provided by the user and the one or more particular classifications of the taxonomy selected by the user. The search engine 122 may return search results that may be displayed to the user as described above.

In one implementation, the IP-based intelligence service 102 or the search engine 122 may enable the user to change or switch the taxonomy to another taxonomy from the taxonomies available to the user. In response to receiving a selection of a new taxonomy, the IP-based intelligence service 102 or the search engine 122 may retrieve new search results based on the search query and the newly selected taxonomy, and return the new search results to a device of a user for display to the user. Additionally or alternatively, the IP-based intelligence service 102 or the search engine 122 may enable the user to change the order and/or the way of displaying the search results to him/her. By way of example and not limitation, the IP-based intelligence service 102 or the search engine 122 may provide display options to the user through the presentation UI module 126.

In some implementations, the taxonomy module may enable a user to submit a new taxonomy to a taxonomy database stored in the memory 120. In one implementation, the taxonomy module may allocate a memory space for the user to store any taxonomy submitted by the user. In some implementations, the taxonomy module may first authenticate or validate the user (e.g., by examining a password and/or username submitted from the user) prior to allowing the user to submit a new taxonomy. In one implementation, the new taxonomy submitted by the user may be viewable and/or usable by the user only. In an alternative implementation, the new taxonomy submitted by the user may be viewable and/or usable by other user and/or the IP-based intelligence service 102 with or without knowledge or permission of the user who submitted the new taxonomy. For example, after the user has submitted the new taxonomy to the taxonomy database, the search engine 122 will enable a computing device of a user to display this new taxonomy together with any previous taxonomies provided by the search engine 122 for performing a search.

In one implementation, one or more of the search engine 122 (and/or the portfolio analysis tool or the taxonomy-based landscape wizard) may further be configured to perform a patent search for a given taxonomy or list of keywords or concepts. By way of example and not limitation, a user may provide a taxonomy including a hierarchy (e.g., a hierarchical tree or forest, etc.) of classifications as an input query. Each classification may be represented by a keyword or a concept. In some implementations, the provided taxonomy may further include respective index for each classification. The user 106 may provide this taxonomy by various input methods including, for example, typing, copying and pasting, uploading a file including the taxonomy, etc. In some implementations, the search engine 122 may further allow a user to provide a name (e.g., an inventor, owner or assignee, etc.) and allow the user determine a patent portfolio of the inventor, owner or assignee under the provided taxonomy or other taxonomy provided by the search engine 122. In one implementation, the search engine 122 may allow the user to provide multiple names (e.g., one or more inventors, owners and/or assignees, etc.) and allow the user to compare patent portfolios between inventors, owners and/or assignees under the provided taxonomy or other taxonomy provided by the search engine 122.

In one implementation, upon receiving the taxonomy, one or more of the search engine 122 (e.g., the keyword search engine, etc.) may perform a patent search for each classification of the taxonomy to obtain a plurality of related patent documents for each classification. The search engine 122 may then compare patent documents obtained for two classifications which are of parent-and-child relationship. For example, the search engine 122 may compare patent documents obtained for a first classification with patent documents obtained for a second classification, where the first classification is an intermediate child of the second classification. The search engine 122 may filter any patent document that is not included in the patent documents for the second classification from the patent documents associated with the first classification. Furthermore, the search engine 122 may compare patent documents associated with a classification with all patent documents obtained for classifications that are its immediate children of that classification, and retain only patent documents for that classification if these patent documents are found in the patent documents obtained for its immediate child classifications. When a patent document is filtered from patent documents associated with a particular classification, the search engine 122 may propagate this information upward and/or downward in order to perform corresponding filtering for patent documents associated with its parents and children. Upon completing searching and filtering for each classification of the taxonomy, the search engine 122 may return search results to a device of a user for presentation. The search results may include, for example, number and information of patents and/or applications found for each classification of the taxonomy, etc.

Additionally or alternatively, in some implementations, the search engine 122 may perform this type of taxonomy search in a top-down manner. By way of example and not limitation, the search engine 122 may identify a classification at the top (e.g., the first level) of the hierarchy (e.g., a hierarchical tree), and perform a keyword or concept search for a keyword or concept associated with that classification at the first level of the hierarchical tree. Upon obtaining or retrieving a plurality of related patent documents for that top classification, the search engine 122 may perform a new keyword or concept search for a keyword or concept provided in each classification that is an immediate child of the top classification, i.e., classifications at the second level of the hierarchical tree. In response to obtaining a plurality of related patent documents for each child classification, the search engine 122 may aggregate all the related patent documents obtained for the second-level classifications having the same immediate parent classification (i.e., the top classification in this case). The search engine 122 may then compare the aggregated patent documents obtained for the child classifications with the patent documents obtained for their immediate parent classification, and retain patent documents that are common thereto. Specifically, a patent document is filtered or removed from the patent documents associated with the parent classification (i.e., the top classification in this case) if that patent document is not found in the aggregated patent documents for all the child classifications of the parent classification. Furthermore, a patent document is filtered or removed from the patent documents associated with an immediate child classification if that patent document is not found in the patent documents for the parent classification. The search engine 122 may repeat searching, aggregating, comparing and filtering for subsequent levels of the hierarchy of the taxonomy until the lowest level is reached, for example. Moreover, when a patent document is filtered from patent documents associated with a particular classification, the search engine 122 may propagate this information upward in order to perform corresponding filtering for patent documents associated with its parents. Upon completing searching and filtering for each classification of the taxonomy, the search engines may return search results to a device of a user for presentation. The search results may include, for example, number and information of patents and/or applications found for each classification of the taxonomy, etc.

Additionally or alternatively, in some implementations, the search engine 122 may perform this type of taxonomy search in a bottom-up manner. For example, the search engine 122 may identify one or more classifications at the lowest level of the hierarchy, and perform a keyword or concept search for a keyword or concept associated with each of the one or more classifications at the lowest level. Upon obtaining or retrieving a plurality of related patent documents for each of these one or more classifications at the lowest level, the search engine 122 may perform a new keyword or concept search for a keyword or concept provided in each classification at the next higher level. In response to obtaining a plurality of related patent documents for each classification at the next higher level, the search engine 122 may aggregate all the related patent documents obtained for the lowest-level classifications having a same immediate parent classification. The search engine 122 may then compare the aggregated patent documents obtained for the child classifications with the patent documents obtained for their immediate parent classification, and retain patent documents that are common thereto. Specifically, a patent document is filtered or removed from the patent documents associated with the parent classification if that patent document is not found in the aggregated patent documents for all the child classifications of the parent classification. Furthermore, a patent document is filtered or removed from the patent documents associated with an immediate child classification if that patent document is not found in the patent documents for the parent classification. The search engine 122 may repeat searching, aggregating, comparing and filtering for subsequent levels of the hierarchy of the taxonomy until the highest level is reached, for example. Moreover, when a patent document is filtered from patent documents associated with a particular classification, the search engine 122 may propagate this information downward in order to perform corresponding filtering for patent documents associated with its children. Upon completing searching and filtering for each classification of the taxonomy, the search engine 122 may return search results to a device of a user for presentation. The search results may include, for example, number and information of patents and/or applications found for each classification of the taxonomy, etc.

Although many of the techniques are described herein as being performed by the IP-based intelligence service 102, any of these techniques may be performed by another device. For example, the device 106 may perform any of the techniques locally via a client application running on the device 106 (e.g., the invention application 114). Further, any of the information of the databases 128-134 may be stored locally at the device 106.

### Example User Interface Screens

FIGS. 2-13 illustrate various screens that may be presented through one or more user interfaces. A user may interact with a user interface (or screen of a user interface) in a variety of manners, such as through text input, image input, touch input, speech input, and so on. The user interface may present a variety of information. Although FIGS. 2-13 generally depict interfaces that display information, the interfaces may additionally, or alternatively, output audio or other forms of content.

FIG. 2 illustrates an example input screen 200 that may be presented to a user to receive input for an analysis. As illustrated, the input screen 200 includes an input field 202 to receive input from the user, such as a patent identifier that identifies a patent document, a company identifier that identifies a company, a classification identifier that identifies a classification, and so on. A patent identifier may include an application number, a publication number, a patent number, and/or any other information associated with a patent document that may uniquely identify the patent document (such as a combination of a name of an inventor and a filing date, etc.). A company identifier may include a name of a company, a number that uniquely identifies the company (e.g., a number used to incorporate the company), trademarks registered to the company (e.g., a trademarked name for a product or the company), names of persons that are associated with the company (e.g., officers, board members, etc.), and so on. A classification identifier may include a name of a classification (e.g., “consumer electronics,” “business methods,” “television,” etc.), information identifying a taxonomy, a classification code (e.g., “225” for data mining), and so on. In some instances, a classification is defined by an organization or agency, such as the U.S. Patent and Trademark Office (USPTO) classes and subclasses or the International Patent Codes (IPC).

Upon receiving the input via the input field 202, the user may select a submit button 204 to receive multiple results screens. Selection of the submit button 204 may cause the input to be sent to the IP-based intelligence service 102. The IP-based intelligence service 102 may perform a variety of processes and provide information to the device 106 for presentation as the multiple results screens. Example results screens are illustrated in FIGS. 3-9. However, in some instances FIGS. 10-13 are also referred to as results screens.

FIG. 3A illustrates an example ownership screen 300 that contains information pertaining to ownership of a patent document. Here, the ownership screen 300 is presented when the user enters U.S. Pat. No. “5,077,804” in the input screen 200. The ownership screen 300 includes information 302 identifying a current or previous owner of the patent document. In this example, the information 302 illustrates that the patent document (e.g., U.S. Pat. No. 5,077,804) was assigned from the inventors to ABC Inc., and then from ABC Inc. to XYZ Corp. The ownership screen 300 also includes information 304 identifying the inventors of the patent document and information 306 that provides a general description of the patent document. In this example, the information 306 includes an abstract of the patent document. In other examples, other types of information may be included, such as a broadest claim, a beginning portion of the detailed description, and so on. Further, the ownership screen 300 shows a front page 308 of the patent document. The user may select the front page 308 to enlarge and explore the patent document, as illustrated in FIG. 4.

As shown in FIG. 3A, the user interface associated with the ownership screen 300 includes navigational items 310 to enable the user to navigate within the results screens. As noted above, the results screens may be generated for output in response to the user selecting the submit button 204 of the input screen 200. In this example, the navigational items 310 are tabs, however, in other examples other types of navigational items may be used, such as back and forward buttons, scroll icons, and so on. In one implementation, navigational items may be represented in a scrollable interface, as illustrated in FIG. 12 and described later on.

FIG. 3B illustrates another example ownership screen 312 that contains information pertaining to ownership of a patent document. Here, the ownership screen 312 is presented when the user enters a company name “XYZ” or “XYZ Corp.” in the input screen 200. The ownership screen 312 includes information 314 about the company XYZ Corp., such as a general description obtained from the company's website, a business article, or otherwise. The ownership screen 312 also includes a graph 316 that shows how information for the company varies over time. The graph 316 may include the company's stock price (e.g., stock information) and bars to indicate a number of applications that have been filed, patents that have been granted, patents that have been acquired, and patents that have expired. The bars may be displayed in different colors or with other markings to indicate the different types of patent documents (e.g., filed, granted, acquired, and expired).

As illustrated, the ownership screen 312 also includes information 318 about competitors of the illustrated company. The information 318 may include, for example, a list of competitors and, for each competitor, a number of patent documents owned by the competitor, a metric indicating a number of patent documents per employee, a metric indicating a number of patent documents per revenue, and so on. The ownership screen 312 may also include information 320 about the company, such as annual revenue of the company (e.g., revenue information), a total number of employees, a description of the company, a metric indicating a number of patent documents per employee, a metric indicating a number of patent documents per revenue, and so forth. Further, the ownership screen 312 may include information 322 about subsidiaries of the company, such as names of subsidiaries of the company and any type of information provided via an ownership screen.

The ownership screen 312 may additionally include information 324 for patent statistics of the illustrated company. The patent statistics may include, for example, information indicating whether or not a number of filings of patent applications over a particular period of time is increasing or decreasing, a total number of grants, a number of patents that will expire in the next few years (e.g., predetermined time period), a mean age of granted patents, a total number of patent applications, an average scope of patent documents owned by the company, and so on.

FIG. 4 illustrates an example reading screen 400 that may enable a user to explore a patent document. In this example, the reading screen 400 is presented when the user selects the front page 308 of the patent document in the ownership screen 300. As such, the user may easily access the patent document with on-click. Here, the user is utilizing touch input to scroll through pages of the patent document. The user may swipe the screen in a particular direction (e.g., from right-to-left (as illustrated), from left-to-right, etc.) to move to a next or previous page of the patent document. The user may also zoom in according to standard zoom techniques (e.g., pinch and zoom, double click, etc.).

FIG. 5 illustrates an example a technology screen 500 that contains information pertaining to relevant classifications associated with the patent document. In particular, the technology screen 500 shows a graphical chart 502 showing a predetermined number of classifications of patent documents that are conceptually related to U.S. Pat. No. 5,077,804. In this example, U.S. Pat. No. 5,077,804 was provided in the input screen 200 and the user selected the technology screen 500 through the tab labeled “2”. The graphical chart 502 may be generated by extracting at least a portion of the patent, performing a concept search with the portion of the patent (e.g., utilize the concept search engine) to identify patent documents that are relevant to a concept of the patent, and identifying a predetermined number of top classifications (e.g., 5-10) associated with the identified patent documents. The top classifications may be determined based on a number of patent documents within the classifications. The top classifications may be presented in the graphical chart 502 with percentages of patent documents with respect to all patent documents in the top classifications.

The technology screen 500 also includes a graphical chart 504 showing a predetermined number of owners of patent documents that are conceptually related to the patent. The graphical chart 504 may be generated by extracting at least a portion of the patent, performing a concept search with the portion of the patent (e.g., utilize the concept search engine) to identify patent documents that are relevant to a concept of the patent, and identifying a predetermined number of top owners (e.g., 5-10) of the identified patent documents. The top owners may be determined based on a number of patent documents owned by the owners. The top owners may be presented in the graphical chart 504 with percentages of owned patent documents with respect to all patent documents of the top owners.

FIG. 6 illustrates an example portfolio screen 600 that contains information 602 pertaining to a patent portfolio of an owner of a patent document (e.g., U.S. Pat. No. 5,077,804). Here, the user has selected the tab labeled “3” of the navigation items 310. The information 602 may be generated by identifying an owner of the input patent document (e.g., XYZ Corp.), identifying patent documents included within a patent portfolio of the owner (e.g., patent documents assigned to the owner), identifying classifications associated with the patent portfolio, and identifying percentages of the classifications that form part of the patent portfolio. As illustrated, the portfolio screen 600 may include an indicator 604 (e.g., a flag) for a classification of the patent document under analysis.

FIG. 7A illustrates an example landscape screen 700 that contains a graphical chart 702 (or plot) showing a patent document relative to other patent documents of a relevant classification along with priority information. The graphical chart 702 may generally show other patent documents that are conceptually related to the patent document under analysis (also referred to as the target patent document) according to classification and priority. Here, the user has selected the tab labeled “4” to view the landscape screen 700.

The graphical chart 702 may be created by determining a concept for at least a portion of the target patent document (e.g., U.S. Pat. No. 5,077,804) and performing a concept search (e.g., with the concept search engine) based on the concept to identify patent documents that a relevant to the concept of the target patent document (e.g., identify conceptually related patent documents). A predetermined number of top classifications of the conceptually related patent documents may then be identified (e.g., find most populated classifications of the conceptually related patent documents).

The graphical chart 702 may include the predetermined number of top classifications and a classification of the target patent document. The graphical chart 702 may include a first axis that represents time (x-axis in FIG. 7A) and a second axis that represents classifications (y-axis in FIG. 7A). The classifications may be ordered with the classification of the target patent document in the center and other classifications placed according to how populated the other classifications are with patent documents, so that more heavily populated classifications are placed closer to the classification of the target patent document than less heavily populated classifications. In the example of FIG. 7A, the class C is associated with the target patent document (e.g., U.S. Pat. No. 5,077,804). Here, the class D is associated with more conceptually related patent documents to the target patent document than the class E. Accordingly, the class D is placed in closer proximity to the class C than the class E.

As illustrated, the graphical chart 702 may display patent documents with icons that represent different types of information for the patent documents. For example, in FIG. 7A, a shape of an icon indicates whether the patent document is filed, published, issued, or undergoing post-issuance review. To illustrate, a circle icon may represent an issued or granted patent, while a square icon may represent a published patent that has not yet issued (e.g., available to the public and pending). Further, the icons may indicate owners of the patent documents. To illustrate, patent documents that are assigned to a particular company may be presented with red icons, while patent documents that are assigned to a different company may be presented with blue icons. Additionally, or alternatively, the icons may be sized according to scope of one or more claims of the associated patent documents. In one example, patent documents that are associated with relatively broad claim scope may be represented with larger shapes than icons for patent documents that are associated with relatively narrow claim scope.

Although the example of FIG. 7A illustrates particular types of information that is conveyed through color, shape, and/or size, it should be appreciated that color, shape, size, or any other indicator may be used to convey the information, such as shading, stippling, shadowing, etc.

In some instances, a user may view information about a patent document by selecting an associated icon displayed in the graphical chart 702. For example, a user may provide touch input to select an icon or hover a pointer over the icon, and in response, information about the patent document may be presented in an overlaid manner on the graphical chart 702. The information may include, for example, an application or publication number, an owner of the patent document, a scope score for at least one claim of the patent document, a title of the patent document, a filing or priority date of the patent document, etc.

FIG. 7B illustrates another example landscape screen 704 that contains a graphical chart 706 showing a patent document relative to other patent documents of a relevant classification along with priority information. Here, the graphical chart 706 shows a target patent document 708 with a flag. The target patent document 708 is illustrated with other patent documents assigned to the owner of the target patent document 708. This example also includes triangle icons representing filed applications that have not yet published. These filed applications may be maintained in a private database that is not available to the public but provided to the IP-based intelligence service 102 for processing.

The example graphical chart 706 of FIG. 7B also includes an interactive legend 710 that allows a user to enable or disable patent documents that are associated with a selected owner. For example, the user may select the text “LCL Corp.” in the legend 710 to disable or remove icons representing patent documents that are assigned to LCL Corp. That is, the icons for LCL Corp. may disappear from the graphical chart 706. As illustrated in this example, the icons are filled with stippling, lines, and white filling to identify the different owners of the patent documents.

The landscape screen 704 also includes information 712 for classifications that are included in the graphical chart 706. The information 712 may include a number of patent applications for a classification, a number of granted patents for a classification, a percentage of patent documents that are displayed in the graphical chart 706 that are associated with a classification, and/or an average scope of patent documents within a classification.

FIG. 8 illustrates an example a scope screen 800 that contains information 802 pertaining to a scope score of one or more claims in a patent document (e.g., U.S. Pat. No. 5,077,804). The scope screen 800 may be referred to as the DNA of the patent document. The scope score of the one or more claims may be generated by the claim scope engine discussed above. Here, the information 802 includes a graph that plots scopes of three claims from the patent document. One axis of the graph (e.g., the y-axis) may represent a number of unique words in a claim, while another axis of the graph (e.g., the x-axis) may represent frequency counts of words in a claim throughout a collection of patent documents.

As discussed above in reference to the claim scope engine, each claim can be assigned a first dimensional value (e.g., a y-value) based on a number or count of unique words in the claim and a second dimensional value (e.g., an x-value) based on a commonness of the words used in the claims as governed by frequency counts throughout a collection of patent documents. That is, words are said to be more common if they have relatively higher frequency values within the collection and less common if they have relatively lower frequency values within the collection. In one implementation, the y-value is a function of the count of unique words in a claim, such as the inverse of the unique word count, so that a larger y-value is assigned to claims with fewer unique words and a smaller y-value is assigned to claims with more unique words. In this manner, this first value or coordinate represents an underlying assumption or premise that claims with fewer unique words tend to be broader than claims with more unique words. In other words, shorter claims tend to be broader than longer claims. This is not always the case, particularly when considering claims in life sciences or chemical arts, but it may be considered to be a correct generalization.

The x-value may be a function of a collection-based frequency counts associated with each of the words in the claim. A larger x-value is thus assigned to claims that use relatively more common words for a collection of patent documents being evaluated and a smaller x-value is assigned to claims that use relatively less common words. In this manner, this second value or coordinate represents an underlying assumption or premise that claims with more common words tend to be broader than claims with less common words. Once again, this may not always be the case, but may be considered to be a correct generalization.

The scope screen 800 also includes information 804 about claims of the patent document. Here, the claim language of the broadest claim is presented along with a patent scope for the claim. Although other types of information may be presented.

FIG. 9A illustrates an example screen 900 to enable a user to access other types of information. For example, by selecting a box 902, the user may view portfolio breadth information for an owner of patent document (e.g., company), evaluate trends for an owner of a patent document, and/or see patent-financial metrics of an owner of patent document. An example portfolio breadth is presented in FIG. 9B. By selecting a box 904, the user may view other patents of an inventor, identify key co-inventors, and/or view strongest patents of an inventor. In one implementation, a score of an inventor may be presented along with a patent document of an inventor or other information. The score of the inventor may be generated by identifying an inventor of an identified patent document and determining a score of the inventor based on a number of patent documents on which the inventor is listed and a scope score of each of the patent documents on which the inventor is listed (e.g., summing the number of patent documents and the scores of the patent documents).

By selecting a box 906, the user may identify key patents of a technology, identify key inventors of a technology, and/or view top owners of a technology. By selecting a box 908, the user may see key claim limitations of a patent document and/or view a validity screen. Further, by selecting a box 910, the user may view contact information for contacting a customer service representative (e.g., telephone number, email address, etc.) and/or be put in directed contact with customer service representative in a real-time chat and/or through telephone.

FIG. 9B illustrates an example portfolio breadth screen 912 that may be presented when a user selects the box 902. Here, the portfolio breadth screen 912 includes a graph 914 that shows a number of patent documents of a patent portfolio for the different patent scope scores. The x-axis represents a patent scope score and the y-axis that represents a patent count (e.g., number of patents). To illustrate, a bar 916 indicates that there are roughly 100 patent documents in the patent portfolio that are associated with a scope score that is in 82 percentile. As illustrated by the graph 914, the patent portfolio under analysis has roughly a same amount of patents in the various scope score levels.

The portfolio breadth screen 912 also includes a graph 918 that shows a number of patent documents in the patent portfolio for different classifications. Here, the x-axis represents different classifications and the y-axis that represents a patent count (e.g., number of patents). As illustrated, the patent portfolio includes a relatively large number of patent documents in the 704 classification.

FIG. 9C illustrates an example competitive analysis screen 920 for a company (e.g., a portfolio of a company) that compares portfolio quality distribution of owner, competitors, and class.

FIG. 9D illustrates an example acquisitions screen 922 that presents (e.g., displays) patent documents transferred for a company.

FIG. 10 illustrates an example overview screen 1000 that includes general information about a patent document. In some instances, the overview screen 1000 may be presented as an initial screen upon receiving input from a user that identifies a patent document (e.g., instead of the ownership screen 300 of FIG. 3A or any other result screen). The overview screen 1000 may include information 1002 about a lifespan of the patent document (e.g., a term of the patent) and how much of the lifespan has expired. The overview screen 1000 may also include information 1004 that identifies a scope of the patent application as filed, a scope of the patent as granted, and a difference in scope between the filing and the granting of the patent (e.g., delta percentage). The overview screen 1000 further includes general information 1006 about the patent, such as an application or publication number, a grant number, a filing date, a priority date, an expiration date, names of inventors, an abstract of the patent document, etc. In addition, the overview screen 1000 presents a front page 1008 of the patent document, which may be selected to explore the patent document.

FIG. 11 illustrates an example scope analysis screen 1100 that shows information about patent documents that are most relevant to a target patent portfolio. Here, a user may have identified the target patent portfolio by inputting, for example, a company name via the input screen 200. Upon identifying the target patent portfolio, a concept search (e.g., using the concept search engine) may be performed to find a group of patent documents that are most relevant to the target patent portfolio (e.g., that are conceptually related to patent documents within the target patent portfolio). Owners of the group of patent documents may be identified and a graphical chart 1102 may be presented to show scopes of the group of patent documents.

The graphical chart 1102 may include a bar for each of the owners that indicates a number of patent documents, from among the group of patent documents, that are owned by the respective owner. In the example of FIG. 11, a company A includes the most patent documents from among the group of patent documents, as illustrated by company A having the tallest bar. The graphical chart 1102 also includes a line 1104 that represents an average scope score for patent documents within a portfolio of a respective owner. To illustrate, a point 1106 on the line 1104 shows that company E includes a relatively high average patent scope score for patent documents in company E's patent portfolio. The graphical chart 1102 also includes a line 1108 that represents an average relevance score of the portfolio.

In some instances, the graphical chart 1102 may allow a company to identify other companies that may be relevant to the company's portfolio. In one example, a point where the line 1104 comes in close proximity to the line 1104, such as the point 1106, may be used to identify a company that is relevant to the target portfolio.

FIG. 12 illustrates a scrollable interface 1200 that enables a user to scroll through information items. The scrollable interface 1200 presents a selected information item in a first manner and a non-selected information item in a second manner. The first manner may include displaying the selected information item larger than the non-selected information item. As illustrated in FIG. 12, a selected information item, namely an overview information item 1202, is displayed in a center of the scrollable interface 1200 in an enlarged manner. As also illustrated, a non-selected information item 1204 is displayed to a side of the overview information item 1202 and is displayed smaller than the overview information item 1202. The information items may decrease in size as a distance to the selected information item increase. The scrollable interface 1200 may also include a scroll bar 1206 to illustrate position of the user through the information items.

An information item may include a variety of information, such as any of the screens described herein. In one example, the scrollable interface 1200 enables a user to scroll through the result screens illustrated in FIGS. 3-9. Here, the scrollable interface 1200 may be presented when a user inputs information via the input screen 200. In another example, the scrollable interface 120 presents patent documents associated with a company.

FIG. 13 illustrates an example growth screen 1300 that shows an increase or decrease of patent documents owned by an owner. In particular, the growth screen 1300 includes a graphical chart 1302 that plots an increase or decrease of patent documents in a classification(s) for an owner relative to time. Here, the x-axis represents time (e.g., filing date) and the y-axis represents a rate or percentage of increase or decrease in a number of filings of patent applications and/or in a number of patents granted. In one instance, a user may provide input identifying a company (e.g., patent owner), such as through the input screen 200 of FIG. 2, and the graphical chart 1302 may be provided with lines representing a number of top classifications for the company that are experiencing an increase or decrease in a number of filings or grants of patents.

The graphical chart 1302 includes indicators that represent events, such as an acquisition of a patent document by a represented owner, a divestiture of a patent document by the represented owner, and so on. For example, the graphical chart 1302 illustrates information for a patent owner “company A” and includes an indicator 1304 (e.g., a flag) representing an acquisition of the U.S. Pat. No. 1,234,567 by company A. Here, the user has selected the indicator 1304, and the graphical chart 1302 displays a pop-up window 1306 with information about the indicator 1304 (e.g., the acquisition of the U.S. Pat. No. 1,234,567). The graphical chart 1302 also includes radio controls 1308(a) and 1308(b) to show either classifications with the greatest growth (when the growth radio control 1308(a) is selected) or classifications with the greatest decline (when the decline radio control 1308(b) is selected).

### Example Processes

FIGS. 14, 15, and 16 illustrate example processes 1400, 1500, and 1600 for employing the techniques described herein. For ease of illustration the processes 1400, 1500, and 1600 are described as being performed in the architecture 100 of FIG. 1. For example, one or more of the individual operations of the processes 1400, 1500, and 1600 may be performed by the device 106 and/or the IP-based intelligence service 102. However, the processes 1400, 1500, and 1600 may be performed in other architectures. Moreover, the architecture 100 may be used to perform other processes.

The processes 1400, 1500, and 1600 (as well as each process described herein) are illustrated as a logical flow graph, each operation of which represents a sequence of operations that can be implemented in hardware, software, or a combination thereof. In the context of software, the operations represent computer-executable instructions stored on one or more computer-readable storage media that, when executed by one or more processors, perform the recited operations. Generally, computer-executable instructions include routines, programs, objects, components, data structures, and the like that perform particular functions or implement particular abstract data types. The order in which the operations are described is not intended to be construed as a limitation, and any number of the described operations can be combined in any order and/or in parallel to implement the process. Further, any number of the operations may be omitted.

FIG. 14 illustrates the example process 1400 to present results screens in response to receiving user input.

At 1402, an input screen may be presented, such as via the device 106. At 1404, input may be received via the input screen. The input may include a patent identifier that identifies a patent document, a company identifier that identifies a company, a classification identifier that identifies a classification, and so on.

At 1406, at least one multiple results screens may be presented, such as via the device 106. A results screen may be presented along with navigation items selectable to present others of the multiple results screens. The multiple results screens may include, for example, an ownership screen, a technology screen, a portfolio screen, a landscape screen, a scope screen, and so on.

The ownership screen may contain information pertaining to ownership of the patent document. The information may include information identifying a current or previous owner of the patent document, patent statistics for an owner of the patent document, stock information for a company that owns the patent document, revenue information for a company that owns the patent document, and so forth.

The technology screen may contain information pertaining to a relevant classification associated with the patent document. The information may include a graphical chart showing a predetermined number of classifications of patent documents that are conceptually related to the patent document and/or a graphical chart showing a predetermined number of owners of patent documents that are conceptually related to the patent document.

The portfolio screen may contain information pertaining to a patent portfolio of an owner of the patent document. The information may identify one or more classifications associated with the patent portfolio and indicate, for each of the one or more classifications, a percentage of the patent portfolio that is associated with the classification.

The landscape screen may contain a graphical plot showing the patent document relative to other patent documents of the relevant classification along with priority information. The graphical plot may include a first axis that illustrates time and a second axis that illustrates a classification of the patent document and a predetermined number of classifications of patent documents that are conceptually related to the patent document.

The scope screen may contain information pertaining to a scope score of one or more claims in the patent document. The information may include a graphical plot showing the scope score of the one or more claims in the patent document relative to claims in other patent documents in the classification of the patent.

FIG. 15 illustrates the example process 1500 for presenting a graphical chart that plots patent documents according to classification and priority date.

At 1502, user input may be received that identifies a patent document. At 1504, at least a portion of the patent document may be extracted. At 1506, one or more concepts of the extracted portion of the patent document may be determined.

At 1508, a search may be performed using the one or more concepts as a query to identify one or more other patent documents that are relevant to the one or more concepts. At 1510, a number of classifications that are associated with a highest number of patent documents from among the one or more patent documents may be identified.

At 1512, a graphical chart may be presented that plots patent document according to classification and priority date. The graphical chart may include a first axis that illustrates time and a second axis that illustrates a classification. In some examples, a classification of a target patent document is placed in substantially a center of classifications. Further, a classification that is more populated than another classification may be placed in closer proximity to the classification of the target patent document than the other classification. The graphical chart may include an interactive legend that allows a user to enable or disable display of patent documents that are associated with a selected owner.

A patent document may be represented in the graphical chart with an icon. The icon (e.g., shape of icon) may indicate whether patent document is filed, published, issued, and/or undergoing post-issuance review. Further, the icon (e.g., size of icon) may indicate a scope of at least one claim from the patent document and/or may indicate an owner of the patent document.

FIG. 16 illustrates the example process 1600 to present various screens and other information related to patent documents.

At 1602, information about a classification may be presented. The information may correspond to a classification that is included within a graphical chart. The information may include, for example, a number of patent applications in the classification, a number of granted patents in the classification, a percentage of patent documents that are displayed in the graphical chart that are associated with the classification, an average scope of patent documents in the classification, and so on.

At 1604, a scope analysis screen may be presented. The scope analysis screen may include a graphical chart that plots information that is relevant to a target portfolio. To do so, a group of patent documents may be found that are relevant to the target patent portfolio. Owners of the group of patent documents may then be identified and the graphical chart may be presented. The graphical chart may indicate a number of patent documents (from among the group of patent documents) that are owned by an owner, an average scope score for patent documents within a portfolio of the owner, an average relevance score of a portfolio, and so on.

At 1606, a score for an inventor may be presented. The score may be determined based on a number of patent documents on which the inventor is listed and a scope score of each of the patent documents on which the inventor is listed.

At 1608, a scrollable interface may be presented to enable navigation through multiple information items. The scrollable interface may cause a selected information item to be larger than a non-selected information item. The non-selected information item may be presented to a side of the selected information item and decrease in size as a distance to the selected information item increases.

At 1610, a growth screen may be presented. The growth screen may include a graphical chart that plots an increase or decrease of patent documents owned by an owner relative to time. The graphical chart may include an indicator that represents an acquisition and/or a divestiture of a patent document.

### CONCLUSION

Although embodiments have been described in language specific to structural features and/or methodological acts, it is to be understood that the disclosure is not necessarily limited to the specific features or acts described. Rather, the specific features and acts are disclosed herein as illustrative forms of implementing the embodiments.

What is claimed is:

1. A method of analyzing intellectual property information on a mobile device, the method comprising:
under control of one or more processors configured with executable instructions:
presenting an input screen of a user interface;
receiving input via the input screen, the input comprising at least one of a patent identifier that identifies a patent document, a company identifier that identifies a company, or a classification identifier that identifies a classification;
upon receiving the input, presenting one of multiple results screens of the user interface along with navigation items selectable to present others of the multiple results screens, the multiple results screens comprising:
an ownership screen that contains information pertaining to ownership of the patent document;
a technology screen that contains information pertaining to relevant classification associated with the patent document;
a portfolio screen that contains information pertaining to a patent portfolio of an owner of the patent document;
a landscape screen that contains a graphical plot showing the patent document relative to other patent documents of the relevant classification along with priority information; and
a scope screen that contains information pertaining to a scope score of one or more claims in the patent document.

2. The method of claim 1, wherein the information contained in the ownership screen includes at least one of:
information identifying a current or previous owner of the patent document;
patent statistics for an owner of the patent document;
stock information for a company that owns the patent document; or
revenue information for a company that owns the patent document.

3. The method of claim 1, wherein the information contained in the technology screen includes at least one of:
a graphical chart showing a predetermined number of classifications of patent documents that are conceptually related to the patent document; or
a graphical chart showing a predetermined number of owners of patent documents that are conceptually related to the patent document.

4. The method of claim 1, wherein the information contained in the portfolio screen identifies one or more classifications associated with the patent portfolio and indicates, for each of the one or more classifications, a percentage of the patent portfolio that is associated with the classification.

5. The method of claim 1, wherein the graphical plot of the landscape screen includes a first axis that illustrates time and a second axis that illustrates a classification of the patent document and a predetermined number of classifications of patent documents that are conceptually related to the patent document.

6. The method of claim 1, wherein the information contained in the scope screen includes a graphical plot showing the scope score of the one or more claims in the patent document relative to claims in other patent documents in the classification of the patent.

7. One or more non-transitory computer-readable media storing computer-readable instructions that, when executed, instruct one or more processors of a mobile device to perform operations comprising:
receiving user input that identifies a first patent document;
determining one or more concepts for at least a portion of the first patent document;
performing a search using the one or more concepts as a query to identify multiple patent documents that are relevant to the one or more concepts;
identifying a predetermined number of classifications that are associated with a highest number of patent documents from among the multiple patent documents;
identifying a second patent document, from among the multiple patent documents, that is associated with at least one of the predetermined number of classifications; and
presenting a graphical chart that plots the first and second patent documents according to classification and priority date, the graphical chart including a first axis that illustrates time and a second axis that illustrates a classification of the first patent document and the predetermined number of classifications.

8. The one or more non-transitory computer-readable media of claim 7, wherein a classification of the predetermined number of classifications that is more populated than another classification of the predetermined number of classifications is placed in closer proximity to the classification of the first patent document than the other classification.

9. The one or more non-transitory computer-readable media of claim 8, wherein the classification of the first patent document is placed in substantially a center of the predetermined number of classifications along the second axis.

10. The one or more non-transitory computer-readable media of claim 7, wherein at least one of the first patent document or second patent document is represented in the graphical chart with an icon that indicates whether the first patent document or second patent document is filed, published, issued, and/or undergoing post-issuance review.

11. The one or more non-transitory computer-readable media of claim 7, wherein at least one of the first patent document or second patent document is represented in the graphical chart with an icon that indicates a scope of at least one claim from the first patent document or second patent document.

12. The one or more non-transitory computer-readable media of claim 7, wherein at least one of the first patent document or second patent document is represented in the graphical chart with an icon that indicates an owner of the first patent document or second patent document.

13. The one or more non-transitory computer-readable media of claim 7, wherein the graphical chart includes an interactive legend that allows a user to enable or disable display of patent documents on the graphical chart that are associated with a selected owner.

14. The one or more non-transitory computer-readable media of claim 7, wherein the operations further comprise:
presenting information about a classification that is included in the graphical chart, the information including at least one of:
a number of patent applications in the classification;
a number of granted patents in the classification;
a percentage of patent documents that are displayed in the graphical chart that are associated with the classification; or
an average scope of patent documents in the classification.

15. The one or more non-transitory computer-readable media of claim 7, wherein the operations further comprise:
identifying a target patent portfolio;
finding a group of patent documents that are relevant to the target patent portfolio;
identifying owners of the group of patent documents; and
presenting another graphical chart that plots for each owner of the identified owners:
a number of patent documents, from among the group of patent documents, that are owned by the respective owner;
an average scope score for patent documents within a portfolio of the respective owner; and
an average relevance score of a portfolio.

16. A method comprising:
under control of one or more processors configured with executable instructions:
receiving input from a user that identifies a patent document;
extracting at least a portion of the patent document;
conducting a concept search using the extracted portion of the patent document; and
presenting a graphical chart that relates the patent document with other patent documents identified by the concept search, the graphical chart plotting the patent document and the other patent documents according to technology and priority data.

17. The method of claim 16, wherein each patent document is represented by a graphical icon on the graphical chart.

18. The method of claim 17, wherein the graphical icon varies according to a scope score derived from at least one claim of a respective patent document.

19. The method of claim 17, wherein a shape of the graphical icon indicates whether the corresponding patent document is filed, published, issued, or undergoing post-issuance review.

20. The method of claim 17, wherein a size of the graphical icon represents a scope score of at least one claim from the respective patent document.

21. The method of claim 16, further comprising:
receiving further user input that selects at least one of the patent document or the other patent documents; and
in response to receiving the further user input, presenting information about the selected patent document in an overlaid manner on the graphical chart.

22. The method of claim 16, further comprising:
identifying an inventor of the patent document;
determining a score of the inventor based at least in part on a number of patent documents on which the inventor is listed and a scope score of each of the patent documents on which the inventor is listed; and
presenting the score of the inventor.

23. The method of claim 16, further comprising:
presenting multiple information items for the patent document in a scrollable interface that causes a selected information item to be larger than a non-selected information item, the non-selected information item being presented to a side of the selected information item and decreasing in size as a distance to the selected information item increases.

24. The method of claim 16, further comprising:
presenting another graphical chart that plots an increase or decrease of patent documents owned by an owner relative to time, the graphical chart including an indicator that represents at least one of an acquisition or a divestiture of one or more of the patent documents.

25. A mobile device comprising:
a display;
one or more processors communicatively coupled to the display; and
memory communicatively coupled to the one or more processors and storing executable instructions that, when executed by the one or more processors, cause the one or more processors to perform a patent analysis process that enables a user to view patent information based on a limited amount of input, the patent analysis process consisting of:
receiving input via an input screen presented on the display, the input comprising at least one a patent identifier of an associated patent document, a company identifier that identifies a company, or a classification identifier that identifies a classification; and
presenting a user interface on the display with navigation items selectable to present multiple results screens that comprise:
an ownership screen that contains information pertaining to ownership of the patent;
a technology screen that contains information pertaining to relevant technology associated to the patent document;
a portfolio screen that contains information pertaining to a patent portfolio of an owner of the patent document;
a landscape screen that contains a graphical plot showing the patent document relative to other patent documents of the relevant technology along with priority information; and
a scope screen that contains information pertaining to a scope score of one or more claims in the patent document.
